(19) United States
(12) Patent Application Publication
(10) Pub. No.: US 2015/0286173 A1
(43) Pub. Date: Oct. 8, 2015

(54) TEMPERATURE DETECTING DEVICE, AND FIXING DEVICE

(71) Applicant: FUJI XEROX CO., LTD., Tokyo (JP)

(72) Inventors: Yuki KUBOTA, Tokyo (JP); Yasutaka GOTO, Kanagawa (JP)

(73) Assignee: FUJI XEROX CO., LTD., Tokyo (JP)

(21) Appl. No.: 14/525,503

(22) Filed: Oct. 28, 2014

(30) Foreign Application Priority Data
Apr. 3, 2014 (JP) 2014-076926

(51) Int. Cl. G03G 15/20

(52) U.S. Cl. CPC G03G 15/2039

(57) ABSTRACT

Provided is a temperature detecting device including a first heat sensing element that is disposed to face an image holding member, a second heat sensing element, an infrared shielding unit that shields the second heat sensing element against radiation with infrared rays, and a substrate with flexibility that holds the first heat sensing element, the second heat sensing element, and the infrared shielding unit, wherein the infrared shielding unit is disposed in a space where the developer is dispersed, and the substrate is bent-disposed such that the first heat sensing element is disposed on an upstream side of the infrared shielding unit in a direction where infrared rays are radiated, the second heat sensing element is disposed on a downstream side of the infrared shielding unit in the direction where infrared rays are radiated, and the substrate is disposed between the image holding member and the infrared shielding unit.

### CROSS-REFERENCE TO RELATED APPLICATIONS

This application is based on and claims priority under 35 USC 119 from Japanese Patent Application No. 2014-076926 filed Apr. 3, 2014.

### BACKGROUND

1. Technical Field

The present invention relates to a temperature detecting device, and a fixing device.

### SUMMARY

According to an aspect of the invention, there is provided a temperature detecting device including:

a first heat sensing element that is disposed to face an image holding member that holds developer;

a second heat sensing element;

an infrared shielding unit that shields the second heat sensing element against radiation with infrared rays; and

a substrate with flexibility that holds the first heat sensing element, the second heat sensing element, and the infrared shielding unit,

wherein the infrared shielding unit is disposed in a space where the developer is dispersed, and

the substrate is bent-disposed such that the first heat sensing element is disposed on an upstream side of the infrared shielding unit in a direction where infrared rays are radiated, the second heat sensing element is disposed on a downstream side of the infrared shielding unit in the direction where infrared rays are radiated, and the substrate is disposed between the image holding member and the infrared shielding unit.

### BRIEF DESCRIPTION OF THE DRAWINGS

Exemplary embodiments of the present invention will be described in detail based on the following figures, wherein:

FIG. 1 is a schematic diagram illustrating a configuration of an image forming apparatus according to an exemplary embodiment of the present invention;

FIG. 2 is a diagram illustrating a configuration of a temperature detecting device according to a first exemplary embodiment included in the image forming apparatus shown in FIG. 1;

FIG. 3 is a diagram illustrating a configuration of a temperature detecting device according to a second exemplary embodiment included in the image forming apparatus shown in FIG. 1;

FIG. 4 is a diagram illustrating a configuration of a temperature detecting device according to a third exemplary embodiment included in the image forming apparatus shown in FIG. 1;

FIGS. 5A and 5B are diagrams illustrating a configuration of a temperature detecting device according to a fourth exemplary embodiment included in the image forming apparatus shown in FIG. 1, in which FIG. 5A is a plan view of the temperature detecting device being flattened out, and FIG. 5B is a cross-sectional view taken along line VB-VB in FIG. 5A;

FIG. 6 is a diagram illustrating a state where the temperature detecting device shown in FIGS. 5A and 5B is built in a main body of an image forming apparatus;

FIG. 7 is a diagram illustrating a configuration of a temperature detecting device according to a fifth exemplary embodiment included in the image forming apparatus shown in FIG. 1;

FIGS. 8A and 8B are diagrams illustrating a configuration of a temperature detecting device according to a sixth exemplary embodiment included in the image forming apparatus shown in FIG. 1, in which FIG. 8A is a plan view of the temperature detecting device being flattened out, and FIG. 8B is a cross-sectional view taken along line VIIIB-VIIIB in FIG. 8A; and

FIG. 9 is a diagram illustrating a state where the temperature detecting device shown in FIGS. 8A and 8B is built in a main body of an image forming apparatus.

### DETAILED DESCRIPTION

Hereinafter, exemplary embodiments of the present invention will be described with reference to the drawings.

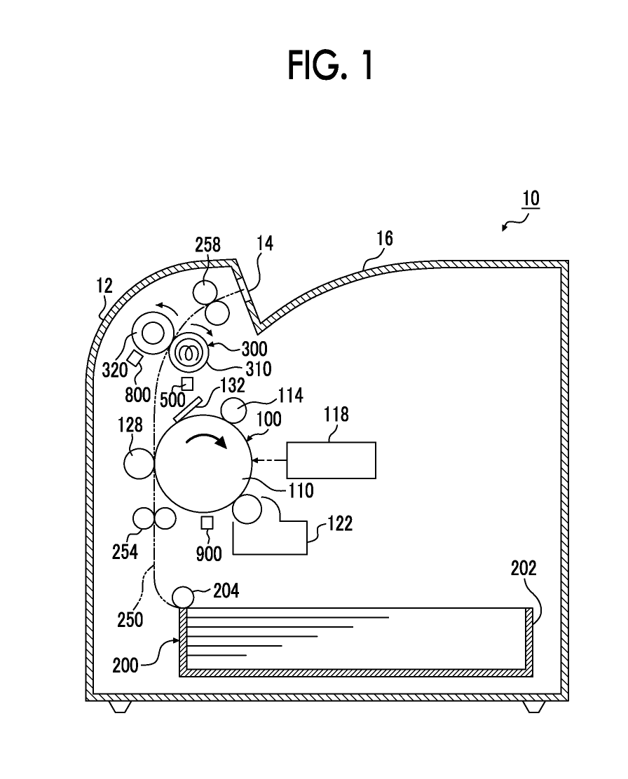

FIG. 1 shows an image forming apparatus 10 according to an exemplary embodiment of the present invention. As shown in FIG. 1, the image forming apparatus 10 includes a main body 12 of the image forming apparatus, and the main body 12 of the image forming apparatus includes an exit port 14 that exits a paper used as a recording medium. An upper surface of the main body of the image forming apparatus is used as an exit unit 16 for exiting the paper.

In the main body 12 of the image forming apparatus, there are provided an image forming unit 100 that forms a developer image on the paper, a paper feeder 200 that feeds the paper to the image forming unit 100, and a fixing device 300 that fixes on the paper the developer image that is formed by the image forming unit 100 and transferred to the paper. In the main body 12 of the image forming apparatus, a transporting path 250 for transporting the paper is formed.

The image forming unit 100 includes a photoconductor drum 110. The photoconductor drum 110 is a member for holding developer on a surface of the photoconductor drum 110 and is used as a developer holding member for holding developer. The image forming unit 100 includes a charging device 114, a latent image forming device 118, a developing device 122, a transfer device 128 and a clean device 132. The charging device 114 charges the surface of the photoconductor drum 110. The latent image forming device 118 radiates with light the charged surface of the photoconductor drum 110 to form a latent image on the surface of the photoconductor drum 110. The developing device 122 develops the latent image formed on the surface of the photoconductor drum 110 using the developer to form a developer image on the surface of the photoconductor drum 110. The transfer device 128 transfers the developer image formed on the surface of the photoconductor drum 110 to the paper. The clean device 132 cleans the surface of the photoconductor drum 110.

The paper feeder 200 includes a paper storage unit 202 that stores the stacked papers and a pulling out roll 204 that pulls a paper on top of papers in the paper storage unit 202 out to the transporting path 250.

The transporting path 250 is a transporting path for transporting toward the exit port 14 the paper fed from the paper feeder 200, and the pulling out roll 204, registration rolls 254, the transfer device 128, the photoconductor drum 110, the fixing device 300, and exit rolls 258 are disposed along the transporting path 250 in this order from an upstream side in a paper transporting direction.

The registration rolls 254 cause the leading end of the paper to pause in a state where the registration rolls 254 stop rotating, and then start to rotate at a predetermined timing. Accordingly, the registration rolls 254 supplies the paper to a contact portion of the transfer device 128 and the photoconductor drum 110 at a timing at which the developer image formed on the photoconductor drum 110 is transferred to the paper.

The fixing device 300 includes a heating roll 310 and a pressing roll 320, the heating roll 310 is used as a heating member for heating the paper on which the developer image is formed, and the pressing roll 320 is used as a pressing member for pressing the paper to the heating roll 310. A heat source such as a halogen lamp is disposed in the heating roll 310. The fixing device 300 allows the heating roll 310 and the pressing roll 320 to respectively rotate in directions indicated by arrows in FIG. 1, and heats and presses the paper passing through a contact portion of the heating roll 310 and the pressing roll 320, thereby fixing the developer image on the paper.

The heating roll 310 is brought into contact with a surface of the paper on which the developer image is formed when the developer image is fixed on the paper. Accordingly, the developer transferred from the paper may adhere to a surface of the heating roll 310 even when a process is performed on the surface of the heating roll 310, for example, the process of applying a releasing agent. The transferred developer remains on the heating roll 310 until being removed from the surface of the heating roll 310 by the clean device or the like (not illustrated). In this manner, the heating roll 310 is used as the developer holding member for holding the developer.

In addition, there is a case where the developer is transferred from the heating roll 310 to the pressing roll 320 when the developer adheres to the heating roll 310 even if a process is performed on the surface of the pressing roll 320, for example, the process of applying releasing agent. The transferred developer remains on the pressing roll 320 until being removed from the surface of the pressing roll 320 by the clean device or the like (not illustrated). In this manner, the pressing roll 320 is used as the developer holding member for holding the developer.

The image forming apparatus 10 includes a temperature detecting device 500 for detecting a temperature of the heating roll 310, a temperature detecting device 800 for detecting a temperature of the pressing roll 320, and a temperature detecting device 900 for detecting a temperature of the photoconductor drum 110. The temperature detecting device 500 is disposed in the vicinity of the heating roll 310, the temperature detecting device 800 is disposed in the vicinity of the pressing roll 320, and the temperature detecting device 900 is disposed in the vicinity of the photoconductor drum 110.

The heating roll 310, the pressing roll 320, and the photoconductor drum 110 are respectively used as the developer holding member as described above, and respectively hold the developer on the surface thereof. Accordingly, there is a case where the developer on the surface of the heating roll 310 is dispersed to adhere to the temperature detecting device 500, where the developer on the surface of the pressing roll 320 is dispersed to adhere to the temperature detecting device 800, or where the developer on the surface of the photoconductor drum 110 is dispersed to adhere to the temperature detecting device 900. In addition, there is a case in the fixing device where the developer or paper dust is dispersed to adhere to the temperature detecting device 500, 800, or 900 during an image formation. The developer or the paper dust adheres to the temperature detecting device 500, 800, or 900, and then the temperature detecting device 500, 800, or 900 becomes dirty. Accordingly, detection of temperature may be incorrect due to dirt in the temperature detecting device 500, 800, or 900, and an error may occur in the detected temperature.

The temperature detecting devices 500, 800, and 900 may have the same configuration. Thus, only the temperature detecting device 500 will be described below, and descriptions of the temperature detecting devices 800 and 900 will be omitted. The configuration of the temperature detecting device 500 described below may be applied to the temperature detecting device 800 or 900 as it is.

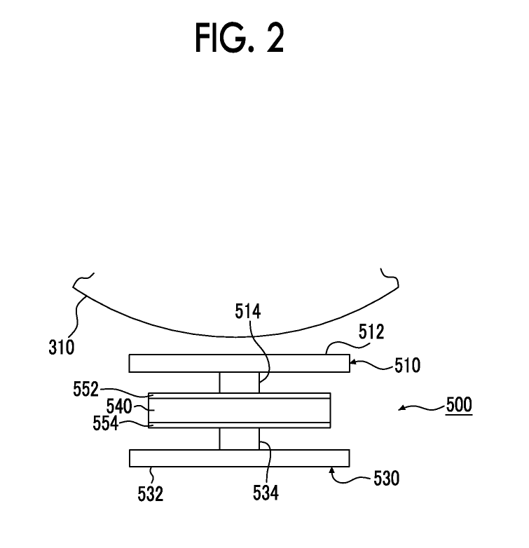

FIG. 2 shows the temperature detecting device 500 according to a first exemplary embodiment. The temperature detecting device 500 includes a first temperature sensor 510 that is used as a first heat sensing unit, a second temperature sensor 530 that is used as a second heat sensing unit, and an infrared reflecting film 540 that is used as an infrared shielding unit for shielding the second temperature sensor 530 against radiation with infrared rays.

The first temperature sensor 510 is disposed to face the heating roll 310. The first temperature sensor 510 includes a substrate 512 and a first heat sensing element 514 that is mounted on the substrate 512. The substrate 512 is formed of a material of which the temperature increases by absorbing infrared radiation from the heating roll 310 as a heat source. This material may include, for example, fluorine, silicone, and a resin made of polymer material such as polyester, polyimide, polyethylene, polycarbonate, and polyphenylene sulfide (PPS).

The first heat sensing element 514 is configured to function as an infrared temperature sensor, is a temperature sensing element of which an electric characteristic changes depending on the temperature, and may use, for example, a thermistor having resistance-temperature characteristic, a thermopile or a metal temperature measuring member.

The second temperature sensor 530 includes a substrate 532, and a second heat sensing element 534 that is mounted on the substrate 532. The substrate 532 is formed of a material of which the temperature increases by absorbing infrared radiation, as with the substrate 512. The second heat sensing element 534 is configured to function as an infrared temperature sensor, as with the first heat sensing element 514, is a temperature sensing element of which an electric characteristic changes depending on the temperature, and may use, for example, a thermistor having a resistance-temperature characteristic, a thermopile or a metal temperature measuring member, as with the first heat sensing element 514.

The infrared reflecting film 540 is a member for shielding against infrared rays so as not to radiate the second heat sensing element 534 of the second temperature sensor 530 with infrared rays and the infrared reflecting film 540 reflects the infrared rays. For example, the infrared reflecting film 540 may include a thin film formed of metal such as copper. The infrared reflecting film 540 is interposed between an insulating film 552 formed of an insulating material and an insulating film 554 formed of an insulating material as with the insulating film 552. The infrared reflecting film 540 is disposed on an opposite side to the heating roll 310 based on the first temperature sensor 510. The infrared reflecting film 540 reflects the infrared rays radiated from the heating roll 310 to shield the second heat sensing element 534 of the second temperature sensor 530 against radiation with the infrared rays.

The first temperature sensor 510 is used for detecting the infrared rays radiated from the heating roll 310, and the second temperature sensor 530 is used for compensating the temperature of the first temperature sensor 510 in the temperature detecting device 500 according to this first exemplary embodiment. That is, in the temperature detecting device 500 according to this first exemplary embodiment, the first temperature sensor 510 detects changes in temperature due to the infrared rays, the second temperature sensor 530 detects changes in temperature excluding changes in temperature due to the infrared rays, and thus changes in temperature due to the infrared rays radiated from the heating roll 310 may be measured using a difference between a detection value of the first temperature sensor 510 and a detection value of the second temperature sensor 530.

In this case, the developer may be dispersed that remains on the surface of the heating roll 310, and the dispersed developer may adhere to the infrared reflecting film 540. A function of the infrared reflecting film 540 for reflecting the infrared rays is degraded when the dispersed developer adheres to the infrared reflecting film 540. Further, the second temperature sensor 530 is likely to detect changes in temperature due to the infrared rays when the function of the infrared reflecting film 540 for reflecting the infrared rays is degraded, thereby the temperature detecting device 500 incorrectly detects the temperature.

The infrared reflecting film 540 is disposed on an opposite side to the heating roll 310 based on the first temperature sensor 510 as shown in FIG. 2, in the temperature detecting device 500 according to this first exemplary embodiment. Accordingly, the developer is unlikely to reach the infrared reflecting film 540 and to adhere to the infrared reflecting film 540 since the first temperature sensor 510 blocks the dispersed developer even though the developer is dispersed from the surface of the heating roll 310. Thus an error in temperature detection is unlikely to occur due to an adhesion of the developer to the infrared reflecting film 540 in the temperature detecting device 500.

In addition, the temperature detecting device 500 according to this first exemplary embodiment may include, for example, an infrared absorbing member for absorbing the infrared rays such as an infrared absorbing film in place of including the infrared reflecting film 540, in order to shield the second heat sensing element 534 against radiation with the infrared rays.

In order for the temperature detecting device 800 (refer to FIG. 1) to have the similar configuration with the temperature detecting device 500 according to the first exemplary embodiment described above, the infrared reflecting film 540 may be disposed on an opposite side to the pressing roll 320 (refer to FIG. 1) based on the first temperature sensor 510. In order for the temperature detecting device 900 (refer to FIG. 1) to have the similar configuration with the temperature detecting device 500 according to the first exemplary embodiment as described above, the infrared reflecting film 540 may be disposed on an opposite side to the photoconductor drum 110 (refer to FIG. 1) based on the first temperature sensor 510.

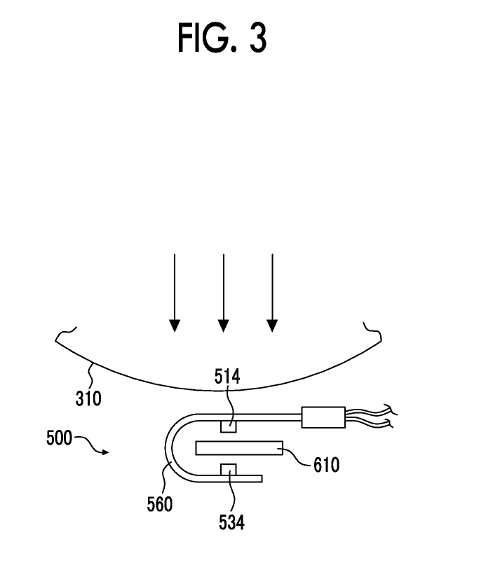

FIG. 3 shows the temperature detecting device 500 according to a second exemplary embodiment of the present invention.

The first heat sensing element 514 is mounted on the substrate 512 and the second heat sensing element 534 is mounted on the substrate 532 in the temperature detecting device 500 according to the first exemplary embodiment described above. On the other hand, the first heat sensing element 514 and the second heat sensing element 534 are mounted on a common substrate 560 and bolded by the common substrate 560 in the temperature detecting device 500 according to this second exemplary embodiment. The temperature detecting device 500 according to this second exemplary embodiment includes an infrared reflecting member 610 having metal or the like formed in a plate shape.

The substrate 560 has flexibility, for example, and may be bent or curved. The substrate 560 is a so-called flexible printed circuit (FPC) and may include, for example, a resin-formed member such as a polyimide film as a base member.

The substrate 560 is bent-disposed in the temperature detecting device 500 according to this second exemplary embodiment such that the first heat sensing element 514 is disposed on a upstream side of the infrared reflecting member 610 (a side of the heating roll 310) in a direction indicated by arrows in FIG. 3 where the infrared rays are radiated from the heating roll 310 (referred to below as an infrared radiation direction) and the second heat sensing element 534 is disposed on a downstream side of the infrared reflecting member 610 (an opposite side to the heating roll 310) in the infrared radiation direction. Accordingly, the infrared reflecting member 610 shields the second temperature sensor 530 against radiation with the infrared rays from the heating roll 310.

The substrate 560 is disposed between the heating roll 310 and the infrared reflecting member 610 in the temperature detecting device 500 according to this second exemplary embodiment. Accordingly, the dispersed developer is unlikely to adhere to the infrared reflecting member 610 since the substrate 560 blocks the currently-dispersed developer even when the developer which remains on the heating roll 310 is dispersed from the surface of the heating roll 310. Thus an error in temperature measurement is unlikely to occur due to an adhesion of the developer to the infrared reflecting member 610 in the temperature detecting device 500 according to this second exemplary embodiment.

In order for the temperature detecting device 800 (refer to FIG. 1) to have the similar configuration with the temperature detecting device 500 according to the second exemplary embodiment described above, the temperature detecting device 800 may be provided in such a manner that the substrate 560 is bent such that the first heat sensing element 514 is disposed on an upstream side of the infrared reflecting member 610 (a side of the pressing roll 320), and the second heat sensing element 534 is disposed on a downstream side of the infrared reflecting member 610 (an opposite side to the pressing roll 320) in a direction where the infrared rays are radiated from the pressing roll 320. In order for the temperature detecting device 900 (refer to FIG. 1) to have the similar configuration with the temperature detecting device 500 according to the second exemplary embodiment as described above, the temperature detecting device 900 may be provided in such a manner that the substrate 560 is bent such that the first heat sensing element 514 is disposed on an upstream side of the infrared reflecting member 610 (a side of the photoconductor drum 110) and the second heat sensing element 534 is disposed on a downstream side of the infrared reflecting member 610 (an opposite side to the photoconductor drum 110) in a direction where the infrared rays are radiated from the photoconductor drum 110.

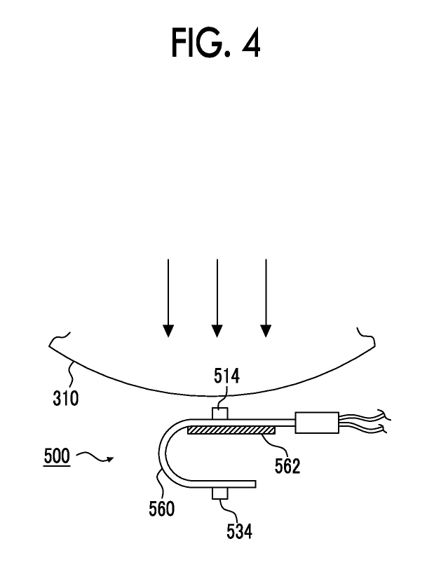

FIG. 4 shows the temperature detecting device 500 according to a third exemplary embodiment of the present invention.

The temperature detecting device 500 according to the second exemplary embodiment described above includes the infrared reflecting member 610. On the other hand, the temperature detecting device 500 according to a third exemplary embodiment includes an infrared reflecting film 562 for shielding against the infrared rays.

More specifically, the temperature detecting device 500 according to the third exemplary embodiment includes the first heat sensing element 514, the second heat sensing element 534, the infrared reflecting film 562 and the substrate 560, the infrared reflecting film 562 is used as an infrared shielding unit for shielding the second heat sensing element 534 against radiation with the infrared rays, and the substrate 560 holds the first heat sensing element 514, the second heat sensing element 534 and the infrared reflecting film 562 with flexibility, as shown in FIG. 4.

The substrate 560 is, for example, a so-called flexible printed circuit (FPC) capable of bending or curving, and includes, for example, a resin-formed member such as a polyimide film as a base member, as with the temperature detecting device 500 according to the second exemplary embodiment described above.

The infrared reflecting film 562 is, for example, a thin film formed of metal such as copper. The infrared reflecting film 562 is provided at a portion of the substrate 560 facing the first heat sensing element 514 through the substrate 560 on an opposite side surface to a surface of the substrate 560 where the first heat sensing element 514 and the second heat sensing element 534 protrude.

The substrate 560 is bent-disposed in the temperature detecting device 500 according to this third exemplary embodiment of the present invention such that the first heat sensing element 514 is disposed on an upstream side of the infrared reflecting film 562 (a side of the heating roll 310) in a direction indicated by arrows in FIG. 4 where the infrared rays are radiated from the heating roll 310, and the second heat sensing element 534 is disposed on a downstream side of the infrared reflecting film 562 (an opposite side to the heating roll 310) in the direction where the infrared rays are radiated. Accordingly, the infrared reflecting film 562 shields the second heat sensing element 534 against radiation with the infrared rays from the heating roll 310 in this temperature detecting device 500.

The substrate 560 is disposed between the heating roll 310 and the infrared reflecting film 562 in the temperature detecting device 500 according to this third exemplary embodiment of the present invention. Accordingly, the dispersed developer is unlikely to adhere to the infrared reflecting film 562 since the substrate 560 blocks the currently-dispersed developer even when the developer which remains on the heating roll 310 is dispersed from the surface of the heating roll 310. Thus an error in temperature measurement is unlikely to occur due to an adhesion of the developer to the infrared reflecting film 562 in the temperature detecting device 500 according to this third exemplary embodiment.

In order for the temperature detecting device 800 (refer to FIG. 1) to have the similar configuration with the temperature detecting device 500 according to the third exemplary embodiment described above, the temperature detecting device 800 may be provided in such a manner that the substrate 560 is bent such that the first heat sensing element 514 is disposed on an upstream side of the infrared reflecting film 562 (a side of the pressing roll 320) in a direction where the infrared rays are radiated from the pressing roll 320, and the second heat sensing element 534 is disposed on a downstream side of the infrared reflecting film 562 (an opposite side to the pressing roll 320) in the direction where the infrared rays are radiated. In order for the temperature detecting device 900 (refer to FIG. 1) to have the similar configuration with the temperature detecting device 500 according to the third exemplary embodiment as described above, the temperature detecting device 900 may be provided in such a manner that the substrate 560 is bent such that the first heat sensing element 514 is disposed on an upstream side of the infrared reflecting film 562 (a side of the photoconductor drum 110) in a direction where the infrared rays are radiated from the photoconductor drum 110, and the second heat sensing element 534 is disposed on a downstream side of the infrared reflecting film 562 (an opposite side to the photoconductor drum 110) in the direction where the infrared rays are radiated.

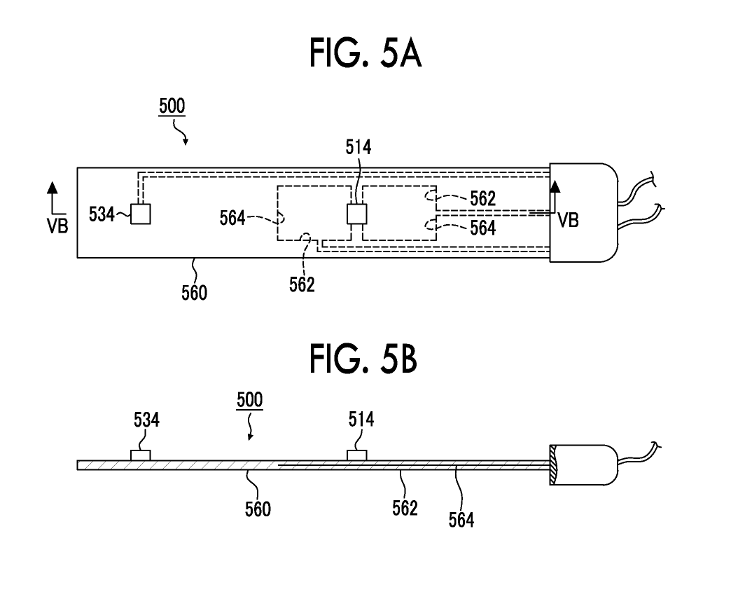

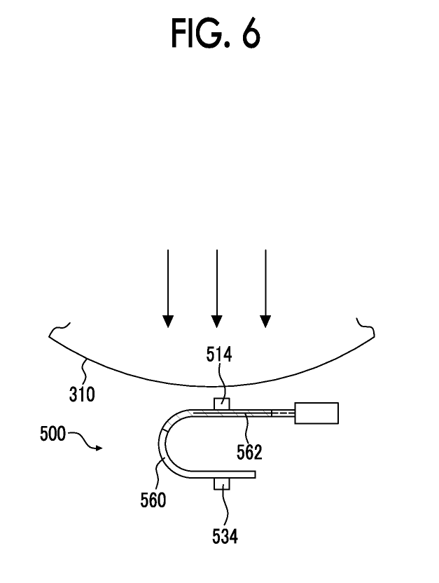

FIGS. 5A to 6 show the temperature detecting device 500 according to a fourth exemplary embodiment of the present invention. The infrared reflecting film 562 is provided at a portion of the substrate 560 facing the first heat sensing element 514 through the substrate 560 on an opposite side surface to a surface of the substrate 560 where the first heat sensing element 514 and the second heat sensing element 534 protrude in the temperature detecting device 500 according to the third exemplary embodiment of the present invention (refer to FIG. 4). On the other hand, the infrared reflecting film 562 doubles as a wiring portion 564 and the infrared reflecting film 562 is formed by the wiring portion 564 in the temperature detecting device 500 according to this fourth exemplary embodiment, as shown in FIGS. 5A and 5B. The wiring portion 564 is connected to the first heat sensing element 514, for example, in order to introduce an electric signal from the first heat sensing element 514 outwardly. The wiring portion 564 is formed, for example, of metal such as copper and disposed to surround the first heat sensing element 514 inside the substrate 560.

The substrate 560 is bent-disposed as shown in FIG. 6 such that the first heat sensing element 514 is disposed on an upstream side of the infrared reflecting film 562 (a side of the heating roll 310) in a direction indicated by arrows in FIG. 6 where the infrared rays are radiated from the heating roll 310, and the second heat sensing element 534 is disposed on a downstream side of the infrared reflecting film 562 (an opposite side to the heating roll 310) in the direction where the infrared rays are radiated in the temperature detecting device 500 according to the fourth exemplary embodiment of the present invention, as with the temperature detecting device 500 according to the third exemplary embodiment (refer to FIG. 4). Accordingly, the infrared reflecting film 562 shields the second heat sensing element 534 against radiation with the infrared rays from the heating roll 310 in this temperature detecting device 500.

The wiring portion 564 is buried in the substrate 560, which doubles as the infrared reflecting film 562 in the temperature detecting device 500 according to this fourth exemplary embodiment of the present invention. Accordingly, the dispersed developer is unlikely to adhere to the infrared reflecting film 562 since the substrate 560 blocks the currently-dispersed developer even when the developer which remains on the heating roll 310 is dispersed from the surface of the heating roll 310.

A wiring portion may double as the infrared reflecting film 562, the wiring portion for introducing an electric signal from the second heat sensing element 534 outwardly in place of using the wiring portion 564 which doubles as the infrared reflecting film 562, the wiring portion 564 for introducing an electric signal from the first heat sensing element 514 outwardly as described above.

In order for the temperature detecting device 800 (refer to FIG. 1) to have the similar configuration with the temperature detecting device 500 according to the fourth exemplary embodiment described above, the temperature detecting device 800 may be provided in such a manner that the substrate 560 is bent such that the first heat sensing element 514 is disposed on an upstream side of the infrared reflecting film 562 (a side of the pressing roll 320) in a direction where the infrared rays are radiated from the pressing roll 320, and the second heat sensing element 534 is disposed on a downstream side of the infrared reflecting film 562 (an opposite side to the pressing roll 320) in the direction where the infrared rays are radiated. In order for the temperature detecting device 900 (refer to FIG. 1) to have the similar configuration with the temperature detecting device 500 according to the fourth exemplary embodiment described above, the temperature detecting device 900 may be provided in such a manner that the substrate 560 is bent such that the first heat sensing element 514 is disposed on an upstream side of the infrared reflecting film 562 (a side of the photoconductor drum 110) in a direction where the infrared rays are radiated from the photoconductor drum 110, and the second heat sensing element 534 is disposed on a downstream side of the infrared reflecting film 562 (an opposite side to the photoconductor drum 110) in the direction where the infrared rays are radiated.

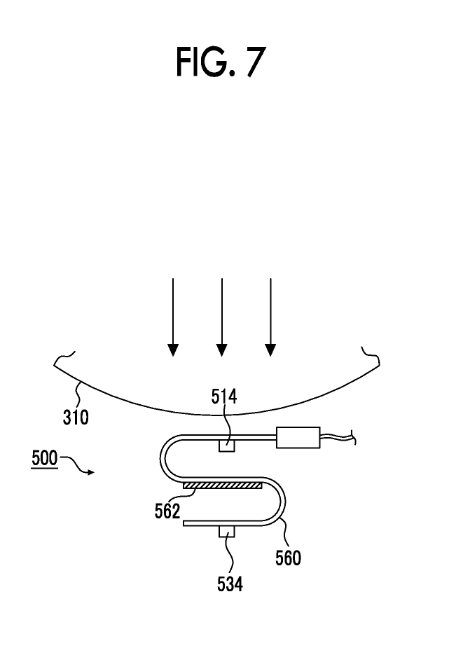

FIG. 7 shows the temperature detecting device 500 according to a fifth exemplary embodiment of the present invention.

The infrared reflecting film 562 is provided at a portion of the substrate 560 facing the first heat sensing element 514 through the substrate 560 on an opposite side surface to a side surface of the substrate 560 where the first heat sensing element 514 and the second heat sensing element 534 protrude in the temperature detecting device 500 according to the third exemplary embodiment described above (refer to FIG. 4). On the other hand, the infrared reflecting film 562 is provided on an opposite side surface to a surface of the substrate 560 where the first heat sensing element 514 and the second heat sensing element 534 protrude and is disposed between the first heat sensing element 514 and the second heat sensing element 534 in a longitudinal direction of the substrate 560 as shown in FIG. 7 in the temperature detecting device 500 according to this fifth exemplary embodiment.

The substrate 560 is bent-disposed at two portions in the temperature detecting device 500 according to this fifth exemplary embodiment of the present invention such that the first heat sensing element 514 is disposed on an upstream side of the infrared reflecting film 562 (a side of the heating roll 310) in a direction indicated by arrows in FIG. 7 where the infrared rays are radiated from the heating roll 310, and the second heat sensing element 534 is disposed on a downstream side of the infrared reflecting film 562 (an opposite side to the heating roll 310) in the direction where the infrared rays are radiated. Accordingly, the infrared reflecting film 562 shields the second heat sensing element 534 against radiation with the infrared rays from the heating roll 310 in the temperature detecting device 500 according to this fifth exemplary embodiment.

The substrate 560 is double-disposed between the heating roll 310 and the infrared reflecting film 562 in the temperature detecting device 500 according to this fifth exemplary embodiment of the present invention. Accordingly, the dispersed developer is unlikely to adhere to the infrared reflecting film 562 since the substrate 560 blocks the currently-dispersed developer even when the developer which remains on the heating roll 310 is dispersed from the surface of the heating roll 310. The temperature detecting device 500 according to the fifth exemplary embodiment of the present invention has the same configuration as the temperature detecting device 500 according to the second exemplary embodiment of the present invention except for the above-described parts, and descriptions of the equivalent parts will be omitted.

In order for the temperature detecting device 800 (refer to FIG. 1) to have the similar configuration with the temperature detecting device 500 according to the fifth exemplary embodiment described above, the temperature detecting device 800 may be provided in such a manner that the substrate 560 is bent-disposed at two portions such that the first heat sensing element 514 is disposed on an upstream side of the infrared reflecting film 562 (a side of the pressing roll 320) in a direction where the infrared rays are radiated from the pressing roll 320, and the second heat sensing element 534 is disposed on a downstream side of the infrared reflecting film 562 (an opposite side to the pressing roll 320) in the direction where the infrared rays are radiated. In order for the temperature detecting device 900 (refer to FIG. 1) to have the similar configuration with the temperature detecting device 500 according to the fifth exemplary embodiment described above, the temperature detecting device 900 may be provided in such a manner that the substrate 560 is bent-disposed at two portions such that the first heat sensing element 514 is disposed on an upstream side of the infrared reflecting film 562 (a side of the photoconductor drum 110) in a direction where the infrared rays are radiated from the photoconductor drum 110, and the second heat sensing element 534 is disposed on a downstream side of the infrared reflecting film 562 (an opposite side to the photoconductor drum 110) in the direction where the infrared rays are radiated.

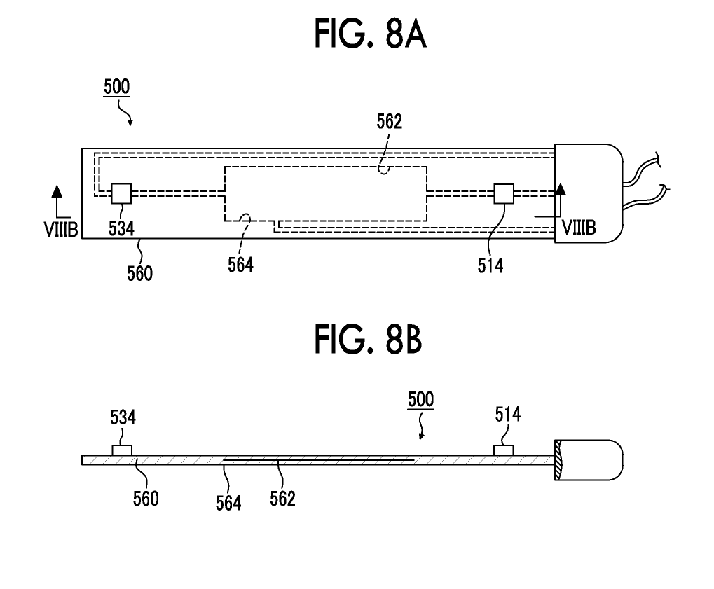

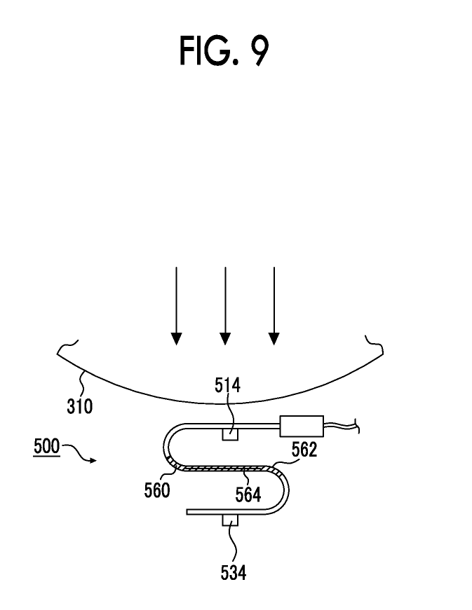

FIGS. 8A to 9 show the temperature detecting device 500 according to a sixth exemplary embodiment of the present invention. The infrared reflecting film 562 is provided on an opposite side surface to a surface of the substrate 560 where the first heat sensing element 514 and the second heat sensing element 534 protrude and is disposed between the first heat sensing element 514 and the second heat sensing element 534 in a longitudinal direction of the substrate 560 in the temperature detecting device 500 according to the fifth exemplary embodiment of the present invention. On the other hand, the infrared reflecting film 562 doubles as the wiring portion 564 and the infrared reflecting film 562 is formed by the wiring portion 564 in the temperature detecting device 500 according to this sixth exemplary embodiment as shown in FIGS. 8A and 8B. The wiring portion 564 is connected to the second heat sensing element 534, for example, in order to introduce an electric signal from the second heat sensing element 534 outwardly. The wiring portion 564 is, for example, formed of metal such as copper. The wiring portion 564 is disposed between the first heat sensing element 514 and the second heat sensing element 534 inside the substrate 560 in the longitudinal direction of the substrate 560.

The substrate 560 is bent-disposed at two portions as shown in FIG. 9 in the temperature detecting device 500 according to this sixth exemplary embodiment such that the first heat sensing element 514 is disposed on an upstream side of the infrared reflecting film 562 (a side of the heating roll 310) in a direction indicated by arrows in FIG. 9 where the infrared rays are radiated from the heating roll 310, and the second heat sensing element 534 is disposed on a downstream side of the infrared reflecting film 562 (an opposite side to the heating roll 310) in the direction where the infrared rays are radiated, as with the temperature detecting device 500 according to the fifth exemplary embodiment described above (refer to FIG. 7). Accordingly, the infrared reflecting film 562 shields the second heat sensing element 534 against radiation with the infrared rays from the heating roll 310 in this temperature detecting device 500.

The wiring portion 564 is buried in the substrate 560, which doubles as the infrared reflecting film 562 in the temperature detecting device 500 according to the sixth exemplary embodiment of the present invention. Accordingly, the developer does not adhere to the infrared reflecting film 562 since the substrate 560 blocks the currently-dispersed developer even when the developer is dispersed from the surface of the heating roll 310, which remains on the heating roll 310.

A wiring portion may double as the infrared reflecting film 562, the wiring portion for introducing an electric signal from the first heat sensing element 514 outwardly in place of using the wiring portion 564 which doubles as the infrared reflecting film 562, the wiring portion 564 for introducing an electric signal from the second heat sensing element 534 outwardly as described above.

In order for the temperature detecting device 800 (refer to FIG. 1) to have the similar configuration with the temperature detecting device 500 according to the sixth exemplary embodiment described above, the temperature detecting device 800 may be provided in such a manner that the substrate 560 is bent at two portions such that the first heat sensing element 514 is disposed on an upstream side of the infrared reflecting film 562 (a side of the pressing roll 320) in a direction where the infrared rays are radiated from the pressing roll 320, and the second heat sensing element 534 is disposed on a downstream side of the infrared reflecting film 562 (an opposite side to the pressing roll 320) in the direction where the infrared rays are radiated. In order for the temperature detecting device 900 (refer to FIG. 1) to have the similar configuration with the temperature detecting device 500 according to the sixth exemplary embodiment described above, the temperature detecting device 900 may be provided in such a manner that the substrate 560 is bent at two portions such that the first heat sensing element 514 is disposed on an upstream side of the infrared reflecting film 562 (a side of the photoconductor drum 110) in a direction where the infrared rays are radiated from the photoconductor drum 110, and the second heat sensing element 534 is disposed on a downstream side of the infrared reflecting film 562 (an opposite side to the photoconductor drum 110) in the direction where the infrared rays are radiated.

The infrared rays radiated from the heating roll 310 is blocked so as not to reach the second heat sensing element 534 by reflecting the infrared rays by using the infrared reflecting film 540 or the like in the above-described temperature detecting device 500 according to each exemplary embodiment of the present invention. However, the infrared rays radiated from the heating roll 310 may be absorbed so as not to reach the second heat sensing element 534 in place of reflecting the infrared rays. In this case, the substrate 560 may absorb the infrared rays at a portion of the substrate 560 where at least the infrared reflecting film 540 is formed in the temperature detecting device 500 according to each exemplary embodiment of the present invention. For example, the material of the substrate 560 may be changed to a material that is likely to absorb the infrared rays or the color of the substrate 560 may be changed to black which has a property that is likely to absorb the infrared rays in order for the substrate 560 to absorb the infrared rays.

Respective exemplary embodiments of the present invention may be applied to an image forming apparatus such as a copier, a facsimile, and a printer, a fixing device that is used in, for example, the image forming apparatus, and a temperature detecting device that is used in, for example, the image forming apparatus as described above.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. A temperature detecting device comprising:
a first heat sensing element that is disposed to face an image holding member that holds developer;
a second heat sensing element;
an infrared shielding unit that shields the second heat sensing element against radiation with infrared rays; and
a substrate with flexibility that holds the first heat sensing element, the second heat sensing element, and the infrared shielding unit,
wherein the infrared shielding unit is disposed in a space where the developer is dispersed, and
the substrate is bent-disposed such that the first heat sensing element is disposed on an upstream side of the infrared shielding unit in a direction where infrared rays are radiated, the second heat sensing element is disposed on a downstream side of the infrared shielding unit in the direction where infrared rays are radiated, and the substrate is disposed between the image holding member and the infrared shielding unit.

2. The temperature detecting device according to claim 1,
wherein the infrared shielding unit includes a wiring portion that introduces an electric signal from the first heat sensing element or the second heat sensing element outwardly.

3. The temperature detecting device according to claim 1,
wherein the infrared shielding unit includes a film formed on the substrate.

4. The temperature detecting device according to claim 1,
wherein the substrate is flexibly bent at two parts of the substrate.

5. The temperature detecting device according to claim 2,
wherein the substrate is flexibly bent at two parts of the substrate.

6. The temperature detecting device according to claim 3,
wherein the substrate is flexibly bent at two parts of the substrate.

7. A fixing device comprising:
a heating member that heats a recording medium on which a developer image is formed;
a first heat sensing element that is disposed to face the heating member;
a second heat sensing element;
an infrared shielding unit that shields the second heat sensing element against radiation with infrared rays; and
a substrate with flexibility that holds the first heat sensing element, the second heat sensing element, and the infrared shielding unit,
wherein the infrared shielding unit is disposed in a space where the developer is dispersed, and
the substrate is bent-disposed such that the first heat sensing element is disposed on an upstream side of the infrared shielding unit in a direction where infrared rays are radiated, the second heat sensing element is disposed on a downstream side of the infrared shielding unit in the direction where infrared rays are radiated, and the substrate is disposed between the heating member and the infrared shielding unit.

8. A fixing device comprising:
a heating member that heats a recording medium on which a developer image is formed;
a pressing member that presses the recording medium to the heating member;
a first heat sensing element that is disposed to face the pressing member;
a second heat sensing element;
an infrared shielding unit that shields the second heat sensing element against radiation with infrared rays; and
a substrate with flexibility that holds the first heat sensing element, the second heat sensing element, and the infrared shielding unit,
wherein the infrared shielding unit is disposed in a space where the developer is dispersed, and
the substrate is bent-disposed such that the first heat sensing element is disposed on an upstream side of the infrared shielding unit in a direction where infrared rays are radiated, the second heat sensing element is disposed on a downstream side of the infrared shielding unit in the direction where infrared rays are radiated, and the substrate is disposed between the pressing member and the infrared shielding unit.
